(19) United States
(12) Patent Application Publication
(10) Pub. No.: US 2005/0225588 A1
(43) Pub. Date: Oct. 13, 2005

(54) Method and apparatus for nozzle map memory storage on a printhead

(76) Inventors: David G. King, Shelbyville, KY (US); Patrick L. Kroger, Versailles, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/822,359

(22) Filed: Apr. 12, 2004

(51) Int. Cl. B41J 29/393

(52) U.S. Cl. 347/19

(57) ABSTRACT

A printhead having improved performance is provided. The printhead includes a housing having an array of nozzles and a printhead memory incorporated on the housing and containing data pertaining to malfunctioning or missing nozzles of the array.

### BACKGROUND

The present invention relates to printheads for inkjet printers and, more particularly, to methods and apparatuses for compensating for nozzle malfunction in inkjet printheads.

Printheads are an essential component of printers, such as inkjet printers and the like. Printheads typically include an array of nozzles through which ink is propelled from an associated ink reservoir (typically integral with the printhead) to a target sheet, thereby marking the target sheet according to a specific print job command sent by a computer or other like processor associated with the printer. Most printheads for inkjet printers are removable, self-contained cartridges that consist of an ink reservoir and a nozzle array. Current printheads may include a printhead memory for storing manufacturing and identification information such that when the printhead is installed into a printer, the printer may read the printhead memory to determine whether the printhead is compatible with the printer.

As part of the manufacturing process, printheads are put through several functional tests to determine whether each nozzle on the printhead is functioning properly. A typical functional test may require a printhead to print a series of lines or figures on a test page that is visually inspected by an operator to identify the location of any missing or malfunctioning nozzles in the nozzle array. Printheads unable to pass the functional tests typically are scrapped.

In the manufacturing setting, a printhead may be given several opportunities to pass such a series of functional tests. Should a printhead fail the functional tests on its first attempt, it may be set aside to rest for a certain period of time, such as overnight, before being put through the functional tests again. During the rest period, some of the problems that may result in nozzle malfunction, such as air bubbles being trapped in the nozzles, may be corrected. Accordingly, some printheads may undergo a series of functional tests up to three times to determine whether the nozzles are functioning properly. However, if after the third attempt the printhead does not function properly due to missing or malfunctioning nozzles, the printhead would be considered permanently clogged and unrecoverable and therefore to be discarded as scrap.

The test criteria typically are quite strict. For example, the testing standard may be zero missing or malfunctioning nozzles. Given the high number of nozzles on printheads, the zero missing or malfunctioning nozzle standard typically results in an unacceptably high printhead scrap rate. For example, a typical inkjet printer may include a mono (i.e., black) printhead having 640 nozzles. As the number of nozzles on a printhead increases, the probability that a printhead will be discarded as scrap due to the strict testing requirement is substantially increased. Accordingly, there is a need for a printhead and method of printhead operation that reduces the number of printheads considered scrap due to the strict functional test criteria.

### SUMMARY

The present invention is a printhead and method of operation that enables a printhead that has fewer than all of its nozzles functioning to be used in an inkjet printer. Consequently, the printhead of the present invention can be made with a much lower scrap rate than conventional inkjet printheads.

The present invention provides a printhead having a housing with an array of nozzles and a printhead memory incorporated on the housing and containing data pertaining to the nozzles of the array. The data may include information pertaining to missing or malfunctioning nozzles of the array. The printhead may be adapted to be installed into a printer having software or firmware capable of reading the printhead memory, wherein the printer is adapted to use the data stored in the printhead memory to format print jobs.

Another embodiment of the present invention provides a method for improving printhead performance, thereby reducing the need to discard printheads having missing or malfunctioning nozzles. The method includes the steps of providing a printhead having an array of nozzles located on the printhead and a printhead memory incorporated on the printhead and storing data pertaining to the nozzles of the array in the printhead memory. The data may include data pertaining to missing or malfunctioning nozzles. The printhead may be installed into a printer having software or firmware capable of reading the data stored in the printhead memory and then formatting a print job based on the data stored in the printhead memory.

Other features, objects and advantages of the present invention will become apparent to those with ordinary skill in the art in view of the following drawings, the detailed description and the appended claims. It is intended that all such additional features and advantages be included herein within the scope of the present invention.

### BRIEF DESCRIPTION OF THE DRAWINGS

The invention can be understood with reference to the following drawings. In the drawings, like reference numerals designate corresponding parts throughout the several views.

FIG. 1 is a schematic diagram of a printhead according to the present invention; and

FIG. 2 is a schematic diagram of the printhead of FIG. 1 installed into a printer.

### DETAILED DESCRIPTION

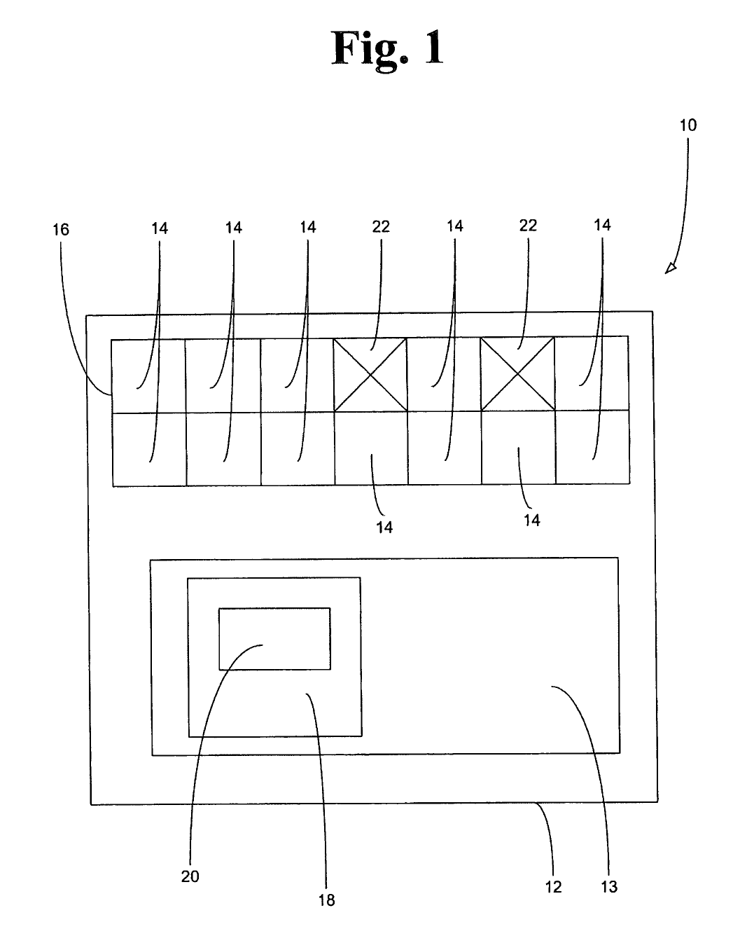

As shown in FIG. 1, a printhead of the present invention, generally designated 10, includes a housing 12, a heater chip 13 and a plurality of nozzles 14 arranged on the housing 12 in an array 16. A printhead memory 18 may be located on the heater chip 13 or other location on (i.e., mounted on the surface of or within) the housing 12 for storing data 20. The array 16 may include one or more missing or malfunctioning nozzles, such as nozzles 22.

The printhead memory 18 may be any type of memory capable of storing data, such as, but not limited to, fuse memory, floating gate memory, flash memory and programmable read only memory (PROM). This list is only exemplary, and it should be understood that any memory capable of being located on the printhead housing 12 would suffice.

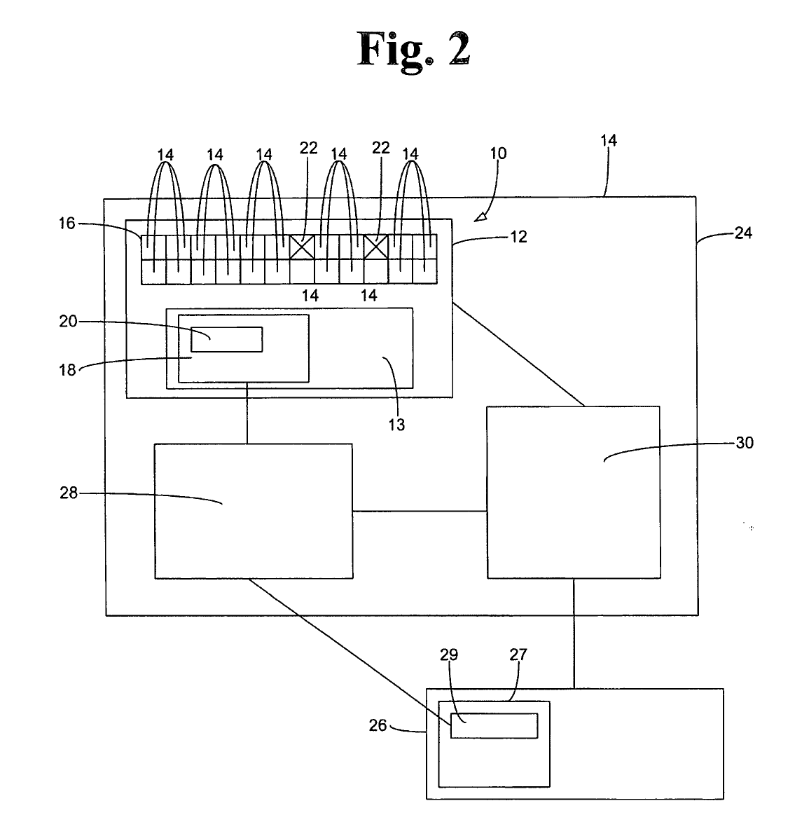

The printhead 10 may be installed into a printer 24, as shown in FIG. 2. The printer 24 may be connected to and communicate with a computer 26 and includes firmware 28 capable of reading data stored in the printhead memory 18 when the printhead 10 is installed in the printer 24. The firmware 28 may be part of, or in communication with, a controller 30 or a computer 26.

The printer 24 may be a host-based printer that is connected to the computer 26, in which software, such as a driver 27 (specific to printer 24), has been installed. The driver 27 may include a formatter 29 for formatting print jobs. Firmware 28 may read data 20 from the printhead memory 18 and pass it to the formatter 29, which, in turn, uses the data 20 to format print jobs. The computer 26 may then pass the formatted print jobs to the controller 30, which in turn instruct the printhead 10 to print target sheets according to the formatted print jobs.

Alternatively, the printer 24 may be a stand-alone printer (not shown) that includes firmware 28 and a controller 30. However, the formatter 29 of the stand-alone printer may be part of the controller 30 rather than computer 26. Accordingly, for the stand alone printer, firmware 28 would read data 20 from the printhead memory 18 and pass it to the controller 30 where the formatter 29 uses the data 20 to format print jobs.

The data 20 stored in the printhead memory 18 pertains to the nozzles 14 of array 16 and may include the status and location of each nozzle 14. Accordingly, the data 20 may be referred to as a nozzle map 20. The status may be whether or not a nozzle 14 is missing or malfunctioning and the location may be the location of a nozzle 14, 22 within the array 16. Accordingly, should the array 16 include a missing or malfunctioning nozzle 22, such information will be stored as data 20 in the printhead memory 18. Therefore, when the printhead 10 is installed into the printer 24, the firmware 28 would read the data 20 from the printhead memory 18, specifically the location and status of missing or malfunctioning nozzles 22. The firmware 28 then communicates the data 20 to the formatter 29 such that the formatter 29 may format the print job to bypass the missing or malfunctioning nozzles 22 or compensate for the missing or malfunctioning nozzles 22 using a compensating technique such as shingling (i.e., compensating for missing or malfunctioning nozzles 22 during subsequent passes of the printhead 10 with functioning nozzles 14).

The data 20 pertaining to the status and location of the nozzles 14, 22 (i.e., the nozzle map 20) is stored in the printhead memory 18 at the time the printhead 10 is manufactured. The process of storing the data 20 in the printhead memory 18 may be accomplished as follows. During manufacture of the printhead, a functional test may be performed on the printhead 18 to detect and identify the location of missing or malfunctioning nozzles 22. These functional tests may be performed in test printers capable of writing directly to the printhead memory 18. When an operator inspects a test page printed by the printhead 10, the location of missing or malfunctioning nozzles 22 may be identified. The operator may enter such information into a computer (not shown) controlling the test printer so that the computer stores the information pertaining to missing or malfunctioning nozzles directly in the printhead memory 18. The scrap rate of printheads having missing or malfunctioning nozzles is thereby reduced since, by storing data 20 pertaining to the status and location of the nozzles 22 in the printhead memory 18, a printhead having fewer than all nozzles operational may be used in a printer capable of reading the nozzle map and making appropriate adjustments in the firing sequence of the functioning nozzles of an array 16.

Alternatively, the process of storing the data 20 to the printhead memory 18 may be automated. The automated process may use an automated detection system (not shown) to identify the location of missing or malfunctioning nozzles 22 and store the location directly in the printhead memory 18. A method and sensor for detecting missing or malfunctioning nozzles 22 is disclosed in U.S. Patent Application Publication No. 2003/0137549 to Adkins et al., which is hereby incorporated by reference.

A method for improving printhead performance is also provided in accordance with the present invention. The method includes performing functional tests on the printhead 10 during manufacture to detect and determine the location of missing or malfunctioning nozzles 22 within the array 16 of nozzles 14, if any. The status and location of each nozzle 14 may then be stored in the printhead memory 18 as data 20 pertaining to the nozzles 14. Alternatively, the data 20 may only include the status and location of missing or malfunctioning nozzles 22. The printhead memory 18 may be located on the heater chip 13 or other location on the printhead housing 12 such that when the printhead 10 is installed in a printer 24, the firmware 28 of the printer 24 may read the printhead memory 18 and pass the data 20 to the formatter 29 (which may be either part of the controller 30 or part of the driver 27 installed on the computer 26) such that the formatter 29 may format a print job issued by the computer 26 to compensate for the missing or malfunctioning nozzles 22.

Although the invention is shown and described with respect to certain embodiments, it is obvious that equivalents and modifications will occur to those skilled in the art upon reading and understanding the specification. The present invention includes all such equivalents and modifications and is limited only by the scope of the claims

1. A printhead comprising:
a housing having an array of nozzles; and
said housing including a printhead memory containing data pertaining to said nozzles of said array.

2. The printhead of claim 1 wherein said data includes a location of at least one missing or malfunctioning nozzle of said array.

3. The printhead of claim 1 wherein said data includes at least one of a status or a location of said nozzles of said array.

4. The printhead of claim 1 wherein said printhead is adapted to be installed into a printer having firmware capable of reading said data from said printhead memory.

5. The printhead of claim 4 wherein said printer is adapted to use said data to format print jobs.

6. A method of making a printhead comprising the steps of:
providing a printhead having a housing including an array of nozzles and a printhead memory; and
storing data pertaining to said nozzles of said array in said printhead memory.

7. The method of claim 6 wherein said data includes a location of at least one missing or malfunctioning nozzle of said array.

8. The method of claim 6 wherein said data includes at least one of a status or a location of said nozzles of said array.

9. A method of making a printer comprising the steps of:
providing a printhead having a housing including an array of nozzles and a printhead memory; and
storing data pertaining to said nozzles of said array in said printhead memory, wherein said data pertaining to said nozzles of said array includes a status and location of at least one missing or malfunctioning nozzle.

10. The method of claim 9 further comprising the step of installing said printhead into a printer having firmware capable of reading said printhead memory.

11. The method of claim 10 wherein said firmware reads said printhead memory and a formatter formats a print job based on said data pertaining to said nozzles.

12. The method of claim 11 wherein said data pertaining to said nozzles includes a location of at least one missing or malfunctioning nozzle and said printer compensates for said at least one missing or malfunctioning nozzle by shingling.

13. The method of claim 9 wherein said storing step includes storing a location of missing or malfunctioning nozzles using an operator performing a standard functional test.

14. The method of claim 9 wherein said storing step includes storing a location of missing or malfunctioning nozzles using an automated detection system.

15. A printhead comprising:
a housing having an array of nozzles;
said housing including a printhead memory containing data pertaining to at least a location and status of at least one missing or malfunctioning nozzle of said array; and
wherein said printhead is adapted to be installed into a printer having firmware capable of reading said data from said printhead memory and passing said data to a formatter for formatting print jobs according to said data.
